(19) United States
(12) Patent Application Publication
(10) Pub. No.: US 2026/0234824 A1
(43) Pub. Date: Aug. 13, 2026

(54) SYSTEM FOR PRODUCING COMPRESSED HYDROGEN

(71) Applicant: CERES INTELLECTUAL PROPERTY COMPANY LIMITED, West Sussex (GB)

(72) Inventors: Hacib BEN AISSA, West Sussex (GB); Joshua Claydon RYLEY, West Sussex (GB)

(21) Appl. No.: 19/153,652

(22) PCT Filed: Feb. 7, 2024
(86) PCT No.: PCT/GB2024/050331

§ 371 Date: Aug. 5, 2025

(30) Foreign Application Priority Data
Feb. 8, 2023 (GB) 2301791.6

(51) Int. Cl. C25B 15/08; B01D 53/04; C25B 1/042; C25B 9/67; C25B 9/73

(52) U.S. Cl. CPC C25B 15/085; B01D 53/0438; C25B 1/042; C25B 9/67; C25B 9/73; B01D 2256/16

(57) ABSTRACT

An electrolyser system (10) and a method of operating an electrolyser system (10), the electrolyser system (10) comprising an electrolyser (16) and a metal hydride or adsorption-desorption compressor (24), wherein the electrolyser (16) has at least one electrolyser cell with a steam input (22) and at least one gas output. The method comprises supplying steam through a first side of the electrolyser cell at the steam input (22), operating the electrolyser (16) to split part of the steam into hydrogen and oxygen in the at least one electrolyser cell, venting a mixture of the hydrogen and the remaining steam from the first side of the electrolyser cell at the at least one gas output (18), passing the mixture into the metal hydride or adsorption-desorption compressor (24), and cryo-adsorbing the hydrogen of the mixture in the metal hydride or adsorption-desorption compressor (24) to compress the hydrogen and desorbing the compressed hydrogen from the metal hydride or adsorption-desorption compressor (24). The electrolyser system (10) is connected

The present invention relates to a system for producing compressed hydrogen.

It is well known that an electrolyser cell (also sometimes known as a regenerative fuel cell) can be used to convert water into hydrogen and oxygen. The process is a relatively straightforward process, although it requires a supply of electricity.

Although the oxygen can be a valuable resource, the hydrogen is the main focus of the present invention. That is because the collection and the subsequent storage and/or distribution of the hydrogen is commonly known to be difficult or costly.

Most known hydrogen storage solutions are complex and expensive, due to the small size of the hydrogen particles, and their propensity to escape through the walls of conventional containers, and due to the need to compress them to great pressures, and/or to reduce their temperature to very low temperatures, in order to liquefy the hydrogen. As a consequence, both the hydrogen storage containers and the filling equipment—in particular in respect of the processes and equipment required for compressing or liquefying the hydrogen ready for such storage or transportation—are costly to produce and use. For example, many hydrogen storage solutions require extremely low temperatures—known as cryogenic temperatures. Further, most hydrogen storage solutions require large levels of energy—both to operate the electrolyser and to generate the high pressures and low temperatures required for liquefying (or sufficiently compressing) the hydrogen ready for loading into suitable storage vessels. Yet further, if distributing the hydrogen through pipework, that is also difficult or costly, requiring very expensive pipelines due to the temperatures and pressures involved. More commonly, hydrogen is instead transported in pressure vessels using vehicles.

Instead of compressing the hydrogen using temperature and pressure, which is both energy intensive and noisy, an alternative known approach for bulk-storage of hydrogen utilises metal hydride compression. With metal hydride compression, the storage density of hydrogen can be increased significantly above that of compressed hydrogen gas—potentially to above that of liquefied hydrogen, and without needing the necessarily high pressures and low temperatures involved in producing liquid hydrogen, and using a substantially silent process.

One example of metal hydride compression is discussed in the International Journal of Hydrogen Energy #31(2006 ) 762-768, in a publication by F. Laurencelle, Z. Dehouche, J. Goyette and T.K. Bose entitled “Integrated electrolyser-metal hydride compression system”, dated 26 Aug. 2005. Their process utilises a Stuart electrolyser to generate the hydrogen as a highly pure gas, and each of mains water and waste heat from the Stuart electrolyser to provide cold and hot feeds for the metal hydride compression and extraction. The temperature involved in the compression phase is thus approximately 20° C. and the temperature involved in the extraction phase is approximately 80° C. However, efficiencies noted from this process were less than 5% and it only achieved a low compression rate of 20 l/hr of hydrogen.

Another example of metal hydride compression is discussed in the International Journal of Hydrogen Energy in an article from Feb. 18, 2014 by G. Petitpas, P. Benard, L. E. Klebanoff, J. Xiao, S and M. Aceves, from the Lawrence Livermore National Laboratory, entitled “A Comparative Analysis of the Cryo-compression and Cryo-adsorption Hydrogen Storage Methods”. This discusses using cryo-compression and/or cryo-adsoprtion for storage of hydrogen from a Proton Exchange Membrane (PEM) electrolyser cell. Liquid nitrogen is used for the cryo-compression, with activated carbon being used as the adsorbent. Extraction may then be achieved using passive heating from the environment, or by using heating wires, or waste heat from the PEM electrolyser cell. However, the supply of liquid nitrogen is expensive, and thus this process is also highly cost ineffective.

It is also to be observed that all these metal hydride compression solutions utilise a dry hydrogen feed from the electrolyser cell as both Stuart electrolysers and PEM electrolysers operate at a relatively low temperature-typically at around 80 degrees C. As a result, the water fed to the electrolyser cell's electrolyser is in liquid form, and the hydrogen can naturally release therefrom (as bubbles) at the same time that it is produced in the electrolyser cell. The produced hydrogen is thus effectively dry when it is being compressed in the metal hydride compressor.

It would be desirable to provide a system for producing and storing, or distributing, compressed hydrogen using highly efficient intermediate and high temperature electrolyser cells (aka regenerative fuel cells)—i.e. fuel cells that separate steam, rather than liquid water, into hydrogen and oxygen—whereby the hydrogen produced is wet hydrogen (hydrogen mixed with excess steam). Such electrolyser cells include high efficiency electrolysers such as SOECs. However, there are numerous forms of electrolyser that produce a wet hydrogen output due to them operating at temperatures well in excess of the boiling point of water—for example in excess of 150 or 200 degrees C—whereby the water is a gas (steam), rather than liquid water, and as a result of which the hydrogen vents from the electrolyser in a vented stream of steam.

It should be observed that a skilled person would consider the wet hydrogen to be unsuitable for compression using conventional techniques without the provision first of a system to dry the hydrogen.

According to a first aspect of the present invention there is provided a method of operating an electrolyser system comprising an electrolyser and a metal hydride or adsorption-desorption compressor, wherein the electrolyser has at least one electrolyser cell with a steam input and at least one gas output, the method comprising:
supplying steam through a first side of the electrolyser cell at the steam input;

operating the electrolyser to split part of the steam into hydrogen and oxygen in the at least one electrolyser cell;
venting a mixture of the hydrogen and the remaining steam from the first side of the electrolyser cell at the at least one gas output;
passing the mixture into the metal hydride or adsorption-desorption compressor;
cryo-adsorbing the hydrogen of the mixture in the metal hydride or adsorption-desorption compressor to compress the hydrogen; and
desorbing the compressed hydrogen from the metal hydride or adsorption-desorption compressor;
wherein the electrolyser system is connected to a source of cold waste gas to operate the cryo-adsorption.

In some embodiments the desorption of the compressed hydrogen from the metal hydride or adsorption-desorption compressor is powered using waste heat from the electrolyser.

Typically the steam output is on a cathode side of the or each electrolyser cell of the electrolyser. Hydrogen thus vents on the cathode side.

Typically oxygen instead vents on an anode side of the or each electrolyser cell of the electrolyser.

In some embodiments the operating temperature is in excess of 150 degrees C., or 200 degrees C., or more typically in excess of 300 degrees C., and most likely in excess of 400 degrees C., especially for SOEC electrolyser cells.

With the present invention, water content of the hydrogen/steam mixture from the electrolyser can be condensed or frozen by the cold temperature of the cryo-adsorption, and at least some of the water is separated from hydrogen in the mixture in the metal hydride or adsorption-desorption compressor. As a consequence, upon desorption, the compressed hydrogen will be dry as the water will not have been adsorbed into the metal hydride. In other embodiments the water is at least partially condensed out using a regenerative heat exchanger. The regenerative heat exchanger may be part of the metal hydride or adsorption-desorption compressor.

In some embodiments the cryo-adsorption is operated at a temperature of less than −70 degrees C.

The desorbed compressed hydrogen may be desorbed into suitable storage tanks and thereafter be stored in the storage tanks, or distributed via vehicles or suitable pipework for use in downstream processes, or else it might be further compressed through one or more further cryo-adsorption cycles before then being stored or distributed for use in downstream processes.

In some embodiments the electrolyser is an intermediate or a high temperature electrolyser—for example one with an operating temperature in excess of 400 degrees C., or in excess of 750 degrees C., respectively.

In some embodiments the electrolyser is a solid oxide electrolyser, also known as an SOEC. SOECs are a particularly beneficial form of intermediate temperature electrolyser as they operate at very high efficiencies—typically at least 60%. However, due to their temperatures (usually in excess of 400 degrees C.), the hydrogen always vents in a mixture with steam, and thus it was perceived to be difficult to compress the vented hydrogen without first passing it through a drying process. The present inventors, however, realised that using cryo-adsorption can avoid the need for that additional drying step as the cryo-adsorption performs the drying step automatically by condensing out and freezing the water from the mixture, leaving behind the hydrogen for distribution to the metal hydride adsorbent.

Furthermore, the desorption step can melt any frozen water that collects near the adsorbent, thus allowing it simply to be removed from the metal hydride or adsorption-desorption compressor by it dripping away therefrom.

The condensate from the mixture might be collected as water, or by thawing it out and allowing it to drain into a collection chamber if frozen, for example for recycling back through the electrolyser, thus reducing the external water demand for the electrolyser system. Alternatively, the condensate may be dispersed or drained away to elsewhere.

Typically the at least one electrolyser cell is part of a stack of electrolyser cells. There may be one or more stacks in the electrolyser.

The or each electrolyser cell in a stack may comprise an anode, a cathode and an electrolyte. However, some stacks may additionally comprise dummy cells (e.g. without an electrolyte). Such dummy cells are known in the art for improving temperature distribution to active electrolyser cells within the stack.

In some embodiments, the or each electrolyser cell has an operational stack temperature in excess of 400 degrees C.

In some embodiments the at least one electrolyser cell is a solid oxide electrolyser cell, i.e. the electrochemically active region is a solid oxide. A solid oxide electrolyser cell (SOEC) typically operates in the 400-1100 degrees C. range.

There are many possible forms of SOFC, using different electrochemically active electrolyte chemistries. For example, three well known electrolyte materials are yttria-stabilized zirconia (YSZ), scandia stabilized zirconia (ScSZ) and gadolinium doped ceria (GDC or CGO).

In some embodiments the electrolyser cell system comprises an intermediate-temperature solid oxide electrolyser cell, or IT-SOFC, cell with an operational stack temperature between 400-750 degrees C., more usually 520-620 degrees C. (or perhaps up to 650 degrees C.).

In some embodiments the electrolyser cell system comprises a high temperature electrolyser cell with an operational stack temperature between 750 degrees C. and 1100 degrees C.

In some embodiments the source of waste gas is a source of waste nitrogen. For example it is a supply of waste nitrogen from a cryogenic process, such as from an air separation unit (ASU) that uses a cryogenic air separation process. Nitrogen from such ASUs is typically a waste product from the air separation process, which is instead seeking to separate and collect the oxygen from air, and perhaps also or instead the argon or other inert gases from air.

As such ASUs utilise a cryogenic air separation process, the nitrogen supplied (as the waste) will already be at a suitable temperature already for feeding to the metal hydride or adsorption-desorption compressor for driving the cryo-adsorption of the hydrogen into the adsorbent, usually at a temperature below −70 degrees C. Whilst the ASU operates at much colder temperatures (below the critical point of air, −140 degrees C.) the outlet fluids may have heated up before being used for cryo-adsorption of the hydrogen.

The waste heat for the desorption may be sourced from the mixture, as it will vent from the electrolyser at the operating temperature of the electrolyser—i.e. at or in excess of 150 degrees C., or from an SOEC at or above 400 degrees C.

In some embodiments the waste heat may alternatively or additionally be from the oxygen-enriched gas exiting the second side of the electrolyser cells of the electrolyser. In some embodiments the waste heat may even be at least partially from a separate industrial process—or from any one or more of these sources.

In some embodiments the cold waste gas—preferably nitrogen—exits the metal hydride or adsorption-desorption compressor at an increased temperature versus that at which it enters, and in some embodiments this can be at a temperature above 0 degrees C., whereby it is safe to vent to atmosphere, or for distribution and use in other processes.

Likewise the oxygen enriched gas' temperature can be reduced ready for use elsewhere. Just like the hydrogen, the oxygen enriched gas exits the electrolyser at or close to the operating temperature of the electrolyser, which in the case of an SOEC is at a temperature in excess of 400 degrees C., whereas after its use in desorption of the compressed hydrogen, it will be closer to ambient temperatures.

In some embodiments the oxygen enriched gas from the electrolyser, after passing through the metal hydride or adsorption-desorption compressor, is cycled into an ASU to increase an oxygen content of an air input for the ASU above that of ambient air. This in turn improves the efficiency of the ASU. Preferably the ASU is the source of the cold waste gas—preferably nitrogen from the ASU.

According to the present invention there is also provided an electrolyser system comprising an electrolyser and a metal hydride or adsorption-desorption compressor, wherein the electrolyser has at least one electrolyser cell with a steam input and at least one gas output, a first side of the electrolyser cell being adapted to receive steam for splitting a part thereof into hydrogen and oxygen in the at least one electrolyser cell;
the electrolyser being connected to the metal hydride or adsorption-desorption compressor such that a mixture of the hydrogen and the remaining steam from the first side of the electrolyser cell can be passed into the metal hydride or adsorption-desorption compressor for cryo-adsorption of the hydrogen of the mixture in the metal hydride or adsorption-desorption compressor to compress the hydrogen, and such that the compressed hydrogen can be desorbed from the metal hydride or adsorption-desorption compressor;
wherein the electrolyser system is connected to a source of cold waste gas to operate the cryo-adsorption.

The electrolyser system may comprise any of the optional features defined in respect of the method.

Typically the cryo-adsorption operates at a temperature of less than −70 degrees C.

Typically the electrolyser cell has an operating temperature in excess of 150 degrees C.

In some embodiments the electrolyser system is adapted to utilise the methods as defined above.

In some embodiments the electrolyser is an intermediate or a high temperature electrolyser with an operating temperature in excess of 400 degrees C., or in excess of 750 degrees C., respectively.

In some embodiments the electrolyser is a solid oxide electrolyser.

In some embodiments the at least one electrolyser cell is part of a stack of electrolyser cells.

In some embodiments there are one or more stacks in the electrolyser.

In some embodiments the source of waste gas is a source of waste nitrogen.

In some embodiments the waste nitrogen is from a cryogenic process, such as from an air separation unit (ASU) that uses a cryogenic air separation process.

In some embodiments heat for the desorption is sourced from either the mixture or from the oxygen exiting the electrolyser, or both. Heat might also, or instead, be sourced from an industrial process as waste hear, or even from the energy supply for the electrolyser cells—particularly where the energy supply is nuclear and the electrolyser system in installed in the nuclear power plant.

In some embodiments the electrolyser system is configured such that oxygen from the electrolyser is passed through the metal hydride or adsorption-desorption compressor, and is subsequently cycled into an ASU to increase an oxygen content of an air input for the ASU above that of ambient air.

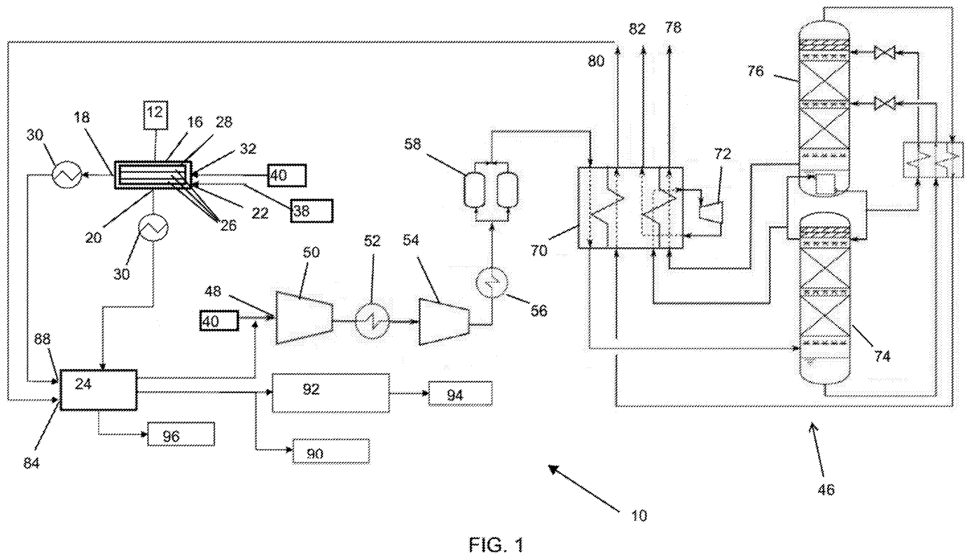

These and other features of the present invention will now be described in greater detail, purely by way of example, with reference to the accompanying drawings, in which:
FIG. 1 shows an electrolyser system according to the present invention in which an electrolyser and an air separation unit are connected to a metal hydride or adsorption-desorption compressor to produce compressed hydrogen; and

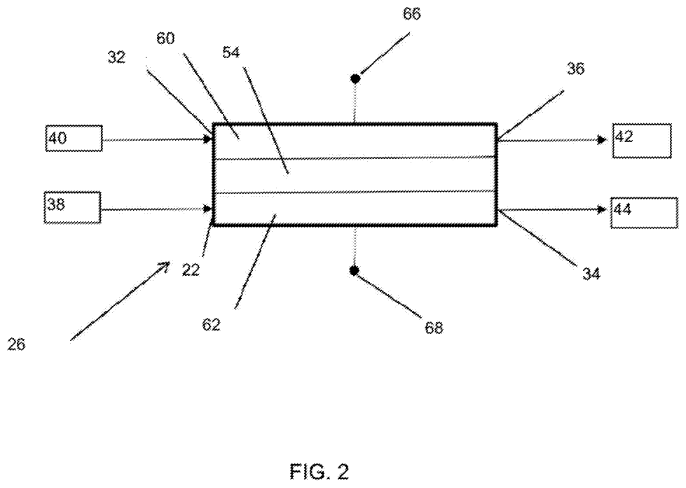

FIG. 2 shows an electrolyser cell and its inputs and outputs.

Referring first to FIG. 1, an electrolyser system 10 is shown. The system comprises an electrolyser 16, a metal hydride or adsorption-desorption compressor 24 and an air separation unit 46.

The electrolyser system 10 uses electricity from a power source 12 to power the electrolyser 16 to generate hydrogen and oxygen from water. The hydrogen and oxygen are vented from the electrolyser 16 as gases via first and second outlets 18, 20 of the electrolyser 16 typically at a temperature that is at or just below the operating temperature of the electrolyser 16. In the case of an electrolyser 16 using solid oxide electrolyser cells—also known as a regenerative solid oxide fuel cells (SOECs or SOFCs), that temperature may be in excess of 400 degrees C. Such electrolysers may be known as intermediate temperature solid oxide electrolyser cells, or IT-SOECs.

The electrical power can be provided by a mains power supply 12 or an off-grid supply 12, although the electrical power is preferably from an alternative energy or green power source, such as solar, wind, thermal, tidal, wave, hydro power or nuclear. Higher energy integration and efficiency can be obtained in a situation where electricity and heat are supplied by locally available sources (e.g Refineries, Petrochemical plants, nuclear reactors, etc.), although dedicated sources can instead be supplied.

It is preferred that the energy source is a green energy source so that the hydrogen produced can be labelled as “green hydrogen”.

The heat of the gases exiting the electrolyser 16—also known as off-gases—can be used as heat sources. In some embodiments this heat may be at least partially recycled back into the electrolyser 16 to help with maintaining a target operating temperature for the electrolyser 16.

The electrolyser 16 also has a steam or water inlet 22 and an air or sweep-flow inlet 32. The hydrogen and oxygen generated from the steam (as described in further detail below) vent from the electrolyser 16 in the off-gases as a wet hydrogen mixture (steam and hydrogen, i.e. hydrogen enriched steam) from the first side outlet 18 and as an sweep gas (typically air)/oxygen mixture, i.e. hot oxygen enriched air, from the second side outlet 20. The oxygen-enriched off gas may simply be termed ‘oxygen-containing’.

In this embodiment, the electrolyser's off-gases—here hot oxygen enriched air and hydrogen enriched steam—can be used to help maintain the operational temperature of the electrolyser 16, as discussed above, but also for powering a desorption process of metal hydride or adsorption-desorption compressor 24, as will be discussed below in respect of the desorption of compressed hydrogen from the metal hydride or adsorption-desorption compressor 24. For the purpose of helping to maintain the operational temperature of the electrolyser 16, however, in this embodiment two heat exchangers 30 are provided—one for each off-gas stream—each of which may be thermally connected to either the housing of the electrolyser 16 or to input streams (e.g. air and steam) for the electrolyser 16, in each case as known in the art.

The electrolyser 16 of this preferred embodiment comprises at least one stack 28 of solid oxide electrolyser cells 26 for carrying out the electrolytic reaction to break down water molecules (in the form of steam) into hydrogen and oxygen molecules—for enriching the off-gases from the electrolyser cells 26. FIG. 1 shows this schematically by illustrating three layers in the stack, each layer representing a separate electrolyser cell 26 arranged in series with the others. In practice a stack may comprise a much higher number of layers—for example 100 cells per stack.

The stack may operate at atmospheric pressure, or at an elevated pressure. Operating at elevated pressures requires more complex and expensive seals (and other components) and poses a greater failure/explosion risk. However, operating at an elevated pressure means elevated pressure off-gases are produced thus reducing the amount of downstream compression required. An elevated pressure, and up to 3 barg (gauge pressure), might advantageously be used in operation to balance these competing factors.

Referring next to FIG. 2, the basic structure and operation of a typical electrolyser 16 is shown by reference to one fuel/electrolyser cell 26 of the stack 28.

The electrolyser cell 26 comprises an anode 60, a cathode 62 and an electrolyte 64. Such a structure for an electrolyser cell 26 is well known in the art. Water—here in the form of steam from a steam source 38—is passed over the cathode 62 and hot air is passed over the anode 60. To power the electrolyser 16, an electric current/voltage is applied across the electrolyser cell 26 via electric terminals/connections 66, 68 at the anode and cathode sides of the electrolyser cell 26. These terminals may be positioned adjacent to one-another on one side of the stack, for example by extending one terminal using a bus bar. As a consequence, an electrolytic reaction occurs across the electrolyte 64, with oxygen ions passing across the electrolyte 64 from the cathode 62 to the anode 60, whereby some of the steam is broken down into hydrogen on the cathode side of the fuel cell 26 and oxygen at the anode side.

The oxygen can be extracted via an air flow or sweep flow provided by the hot air for venting it out of an off-gas outlet 36 on the anode side of the electrolyser cell 26 as an oxygen enriched air 42. The hydrogen can be extracted and vented out of another off-gas outlet 34 on the cathode side of the electrolyser cell 26. This off gas will also contain steam, as the conversion of the steam into oxygen and hydrogen is only in respect of a small proportion of the supplied steam. The hydrogen is thus vented as wet hydrogen 44. Thus the steam exiting the cathode side is hydrogen enriched, and the air exiting the anode side is oxygen enriched. Due to the operating temperature of the electrolyser cell 26—in the case of an SOEC usually in excess of 400 degrees C., those off-gases will be at a similar temperature to the operational temperature of the electrolyser cell 26—i.e. around or in excess of 400 degrees C. in the case of such an SOEC.

Such operational characteristics of a SOEC are well known in the art, but are beneficial for the present invention as the heat of the off-gases is able to be usefully used by the electrolyser system 10, rather than being wasted.

Referring now back to FIG. 1, a further element of an embodiment of the electrolyser system 10 of the present invention is shown. This is the air separation unit 46. An air separation unit or ASU is provided in this embodiment as a provider of cold waste gas. Other sources of cold waste gas can instead be used, such as natural gas dew pointing (propane loop), natural gas let down, stabilisation of natural gas condensate, LPG liquefaction processes, and LNG liquefaction processes.

Air separation units, or cryogenic air separation units, commonly known as ASUS separate atmospheric air into its primary components, typically nitrogen and oxygen, and sometimes also argon and other rare inert gases. The most common method for achieving this air separation is fractional distillation (a cryogenic distillation process). ASU systems, also known as cryogenic air separation units, are built to separate nitrogen or oxygen, and often to co-produce argon, from air.

A common problem with ASUs is that the output of oxygen obtainable from the volume of source gas (usually air) is limited by the volumetric makeup of that air. Ambient air is typically approximately 78% nitrogen, 21% oxygen and 1% partial volume (of argon and other elements/compounds), whereby no matter how much the rate of processing of the air is improved, the process is limited to producing at most 21% of that volume in oxygen. That means that 78% is waste gas (the nitrogen), as oxygen (and potentially the argon or other elements/compounds in the partial volume) is typically the main target output from the air separating unit, especially given the increasing demand for, and thus increasing value of, oxygen.

Another problem that is exemplified by this predominant waste is that ASUs are highly energy inefficient. An ASU needs to operate at cryogenic temperatures, and the energy used to cool the gas to be separated can effectively be lost when the waste nitrogen is vented or otherwise allowed to reheat in storage tanks, or elsewhere downstream of the ASU. The present invention thus seeks to use that cold nitrogen as a cold waste gas for powering the adsorption of hydrogen in the metal hydride or adsorption-desorption compressor 24, as will be described in greater detail below.

As for the ASU itself, it is relatively conventional in form in this illustrated embodiment. For example, the ASU 46 comprises a source gas infeed 48, a compressor 50 for compressing a source gas, a cooler 52 for cooling the compressed source gas, optional further compressors 54 and coolers 56, and a filter system 58—here in the form of a molecular sieve 58—for filtering large particulates or other solids and contaminants out of the compressed air, such as dust and pollen, or carbonaceous deposits such as soot. The ASU 10 then additionally comprises a main heat exchanger 70 with a cryogenic engine 72 for performing cryogenic cooling onto that generally clean (filtered) source gas until it at least partially liquefies. That cryogenically cooled fluid is then passed to distilling columns 74, 76—usually comprising at least two pressure columns—one at a relatively higher pressure than the other, and thus comprising a high pressure column 74 and a low pressure column 76. The distilling columns 74, 76 then selectively distil the fluid out into separate gaseous components at their various boiling temperatures using controlled changes in the temperature and pressure of the liquid, for example by allowing the fluid temperature to rise, or the pressure to drop.

Outputs from the distilling columns 74, 76 then feed back to the main heat exchanger 70, or otherwise vent from the ASU 46, as separated gaseous components such as oxygen 78, nitrogen 80, argon 82 and possibly others (not shown) via separate outputs.

The cryogenic air separation process requires various heat exchangers, air compressors and separation/distilling columns, and the energy for refrigeration (cooling) and condensing/rebuilding the fluid in the separation/distilling columns. In preferred embodiments the energy/electricity for this is provided by green energy sources.

The air separation process is energy-intensive due to the requirement to refrigerate the air to low temperatures (cryogenic temperatures), and to pressurise it to high pressures (to make the low temperature not as low as would otherwise be the case).

Nevertheless, the output temperatures of the separated gases typically remain well below ambient temperatures, if not reheated by an external heat source (e.g. air). The waste part of the separated gases—typically the nitrogen—is thus commonly a wasted cold gas source. With the present invention, however, the waste nitrogen can be utilised as a driver for the compression of the hydrogen from the electrolyser 16. For this purpose the nitrogen exiting the ASU can be directed at a cold feed input 84 of the metal hydride or adsorption-desorption compressor 24.

The metal hydride or adsorption-desorption compressor 24, like that in the journal article entitled “A Comparative Analysis of the Cryo-compression and Cryo-adsorption Hydrogen Storage Methods”, as mentioned above, requires a cold input for operating the adsorption process. The ASU can thus provide that cold source without any separate need to generate liquid nitrogen. The metal hydride or adsorption-desorption compressor 24 thus receives hot hydrogen from the second side outlet 20 of the electrolyser 16 at a hydrogen input 86 of the metal hydride or adsorption-desorption compressor 24 and has the nitrogen from the ASU 46 as a cold source for powering the compression. The hydrogen can thus be compressed through adsorption in the metal hydride or adsorption-desorption compressor 24. Additionally, since the wet hydrogen is cooled a) to below 100 degrees C., and then subsequently to below 0 degrees C., the water in the wet hydrogen condenses and subsequently freezes, and at each transition it can be drained or removed from the hydrogen stream.

The present invention, however, also has a readily available heat source—either the hydrogen's heat or the oxygen's heat (from the electrolyser 16), or both. Thus the electrolyser 16 can additionally provide the energy required for the subsequent desorption of the compressed hydrogen from the metal hydride or adsorption-desorption compressor 24, and for that purpose the oxygen from the first side outlet 18 of the electrolyser is connected to a heat input 88 of the metal hydride or adsorption-desorption compressor 24.

The metal hydride or adsorption-desorption compressor thus has three input streams oxygen enriched air from the electrolyser 16, wet hydrogen from the electrolyser 16 and cold nitrogen from the ASU. It then subsequently has three output streams—nitrogen (potentially warmed to a temperature that is ready for release to atmosphere or for other use as a pure nitrogen source 96, oxygen enriched air—cooled from its electrolyser temperature, and compressed cold hydrogen as it is released through desorption from the metal hydride or adsorption-desorption compressor 24, which hydrogen can be stored 90 or delivered 92 for downstream use 94. Due to the compression process and the use of cryogenic cooling, the compressed hydrogen has the additional benefit of being highly purified in this thermo-compression process.

In some embodiments both the electrolyser and the source of the cold waste gas are powered by green energy. The hydrogen thus then produced is both highly purified and widely recognisable as “green hydrogen”.

A further aspect of the present invention is that the oxygen enriched air from the metal hydride or adsorption-desorption compressor 24 can be cycled into the ASU to increase the oxygen content of the air input for the ASU. This in turn reduces the percentage of nitrogen in the source gas for the first compressor 50 of the ASU 46, and thus increases the efficiency of the ASU 46 as the cooling operations of the ASU are carried out on a lower total volume of waste component of the source gas as the oxygen content is increased above 21%. The integration of the electrolyser 16 and the metal hydride or adsorption-desorption compressor 24 with the ASU 46 can thus enhance the efficiencies of both the metal hydride or adsorption-desorption compressor 24 and the ASU 46 as the waste streams of each of these devices (cold nitrogen and oxygen enriched air—i.e. air with more than 21% and preferably more than 22 or 23% oxygen) can enhance the operational efficiencies of the other, with the electrolyser efficiently providing both the hydrogen for compression and the oxygen enriched air, along with the heat for powering the desorption of the compressed hydrogen. There is thus a significant an inventive synergy between these three devices.

Heat exchangers in the Figures which perform opposing operations (i.e. warming/cooling) may be combined as two sides of a single heat exchanger to increase the temperature difference and thus operate more efficiently.

The present invention has thus been described above, purely by way of example, with reference to the accompanying drawings. Modifications in detail may be made to the invention within the scope of the claims as appended hereto. For instance, features described as part of one embodiment can be used on another embodiment to yield a still further embodiment.

1. A method of operating an electrolyser system comprising an electrolyser and a metal hydride or adsorption-desorption compressor, wherein the electrolyser has at least one electrolyser cell with a steam input and at least one gas output, the method comprising:
supplying steam through a first side of the electrolyser cell at the steam input; operating the electrolyser to split part of the steam into hydrogen and oxygen in the at least one electrolyser cell;
venting a mixture of the hydrogen and the remaining steam from the first side of the electrolyser cell at the at least one gas output;
passing the mixture into the metal hydride or adsorption-desorption compressor;
cryo-adsorbing the hydrogen of the mixture in the metal hydride or adsorptiondesorption compressor to compress the hydrogen; and
desorbing the compressed hydrogen from the metal hydride or adsorptiondesorption compressor;
wherein the electrolyser system is connected to a source of cold waste gas to operate the cryo-adsorption.

2. The method of claim 1, wherein the desorption of the compressed hydrogen from the metal hydride or adsorption-desorption compressor is powered using waste heat from the electrolyser.

3. The method of claim 1, wherein oxygen is vented from a second side of the or each electrolyser cell of the electrolyser.

4. The method of claim 1, wherein the operating temperature of the electrolyser is in excess of 200 degrees C., or optionally in excess of 300 degrees C., or optionally in excess of 400 degrees C.

5. The method of claim 1, wherein water content of the hydrogen/steam mixture from the electrolyser is condensed or frozen by the cold temperature of the cryo-adsorption, and at least some of the water is separated from hydrogen in the mixture in the metal hydride or adsorption-desorption compressor.

6. The method of claim 1, wherein water content of the hydrogen/steam mixture from the electrolyser is at least partially condensed out using a regenerative heat exchanger.

7. The method of an claim 1, wherein the compressed hydrogen is further compressed through one or more further cryo-adsorption cycles.

8. The method of claim 1, wherein the electrolyser is an intermediate or a high temperature electrolyser with an operating temperature in excess of 400 degrees C., or in excess of 750 degrees C., respectively.

9. The method of claim 1, wherein the electrolyser is a solid oxide electrolyser.

10. The method of claim 1, wherein the at least one electrolyser cell is part of a stack of electrolyser cells.

11. The method of claim 1, wherein there are one or more stacks in the electrolyser.

12. The method of claim 1, wherein the source of waste gas is a source of waste nitrogen.

13. The method of claim 12, wherein the waste nitrogen is from a cryogenic process, such as from an air separation unit (ASU) that uses a cryogenic air separation process.

14. The method of claim 1, wherein heat for the desorption is sourced from either the mixture or from the oxygen exiting the electrolyser, or both.

15. The method of claim 1, wherein the oxygen from the electrolyser passes through the metal hydride or adsorption-desorption compressor, and is subsequently cycled into an ASU to increase an oxygen content of an air input for the ASU above that of ambient air.

16. The method of claim 1, wherein the cold waste gas is at a temperature of less than −70 degrees C.

17. An electrolyser system comprising an electrolyser and a metal hydride or adsorption-desorption compressor, wherein the electrolyser has at least one electrolyser cell with a steam input and at least one gas output, a first side of the electrolyser cell being adapted to receive steam for splitting a part thereof into hydrogen and oxygen in the at least one electrolyser cell;
the electrolyser being connected to the metal hydride or adsorption-desorption compressor such that a mixture of the hydrogen and the remaining steam from the first side of the electrolyser cell can be passed into the metal hydride or adsorption-desorption compressor for cryo-adsorption of the hydrogen of the mixture in the metal hydride or adsorption-desorption compressor to compress the hydrogen, and such that the compressed hydrogen can be desorbed from the metal hydride or adsorption-desorption compressor,
wherein the electrolyser system is connected to a source of cold waste gas to operate the cryo-adsorption.

18. The electrolyser system of claim 17, wherein the electrolyser is an intermediate or a high temperature electrolyser with an operating temperature in excess of 400 degrees C., or in excess of 750 degrees C., respectively.

19.-23. (canceled)

24. The electrolyser system of claim 17, wherein heat for the desorption is sourced from either the mixture or from the oxygen exiting the electrolyser, or both.

25. The electrolyser system of claim 17, configured such that oxygen from the electrolyser is passed through the metal hydride or adsorption-desorption compressor, and is subsequently cycled into an ASU to increase an oxygen content of an air input for the ASU above that of ambient air.
